(19) United States
(12) Patent Application Publication
(10) Pub. No.: US 2023/0178259 A1
(43) Pub. Date: Jun. 8, 2023

(54) Method and machine for testing a spacer grid of a nuclear fuel assembly

(71) Applicant: FRAMATOME, Courbevoie (FR)

(72) Inventors: Victor Hatman, Lynchburg, VA (US); Eric Bourdais, Saint Leger Les Paray (FR); Antoine Duret, Villeurbanne (FR); Charles PINTOS, Lyon (FR)

(21) Appl. No.: 17/544,021

(22) Filed: Dec. 7, 2021

(51) Int. Cl. G21C 17/06; G21C 3/18

(52) U.S. Cl. CPC G21C 17/06; G21C 3/18

(57) ABSTRACT

A test method is for testing a spacer grid of a nuclear fuel assembly comprising a bundle of nuclear fuel rods and N spacer grids distributed along the bundle of nuclear fuel rods, where N is a positive integer equal to or greater than four. The method of testing includes providing a test assembly comprising a bundle of test rods shorter than the nuclear fuel rods and three spacer grids distributed along the test rods, generating an impact on the centrally located spacer grid, and measuring and recording at least one impact parameter and/or at least one displacement of said centrally located spacer grid.

### TECHNICAL FIELD

The present disclosure relates to the field of nuclear fuel assemblies, and in particular to the testing of spacer grids of a nuclear fuel assembly.

### BACKGROUND

A nuclear fuel assembly generally includes a bundle of nuclear fuel rods extending along a longitudinal axis and a support skeleton configured to support the nuclear fuel rods.

In particular, the support skeleton includes two longitudinally spaced-apart nozzles, a plurality of guide tubes extending along the longitudinal axis connecting the nozzles to each other, and spacer grids distributed along the guide tubes and attached to the guide tubes, each spacer grid being configured to support the nuclear fuel rods.

Each spacer grid has rod cells through which the nuclear fuel rods pass, each rod cell having a respective nuclear fuel rod passing therethrough and having one or more springs and/or one or more dimples on internal surfaces of the rod cell to transversely and longitudinally hold the nuclear fuel rod passing through that rod cell.

In operation, the nuclear fuel assembly is disposed vertically in the core of a nuclear reactor which is formed of a plurality of nuclear fuel assemblies disposed side-by-side, with a coolant flowing upwardly through the core of the nuclear reactor.

In a nuclear fuel assembly, the spacer grids are critical components that provide spacing between the nuclear fuel rods, including in the event of an earthquake that could cause impacts between adjacent nuclear fuel assemblies and/or impacts of nuclear fuel assemblies with a side wall of a nuclear reactor vessel, or in the event of a loss of coolant accident (LOCA).

The strength and operation of the spacer grids in the event of an impact must be certified by means of certification tests.

### SUMMARY

One of the aims of the present disclosure is to provide a method of testing a spacer grid that allows the limits in service of the spacer grid to be accurately determined and thus the spacer grid to be accurately certified.

To this end, the present disclosure provides a method for testing a spacer grid of a nuclear fuel assembly comprising a nuclear fuel rod bundle and N spacer grids distributed along the nuclear fuel rod bundle, where N is a positive integer equal to or greater than four, the testing method comprising:
providing a test assembly corresponding to a section of the nuclear fuel assembly extending on a fraction of the length of the nuclear fuel assembly, the test assembly comprising a bundle of test rods shorter than the nuclear fuel rods and three spacer grids distributed along the test rods
generating an impact on the centrally located spacer grid, and
measuring and recording at least one impact parameter and/or at least one displacement of said centrally located spacer grid.

The use of a test assembly shorter than a nuclear fuel assembly in which the spacer grids are to be integrated, in which a first spacer grid to be tested is disposed between two second spacer grids, makes it possible to perform a test representative of the conditions that may be encountered by the first spacer grid during operation, while imposing controlled and repeatable stresses on the first spacer grid to ensure the reliability and accuracy of the test.

According to particular embodiments, the test method includes one or more of the following optional features, taken individually or in any technically possible combination:
the test assembly comprises exactly three spacer grids;
in a two-sided impact test, the generation of an impact comprises the application of the spacer grids against stationary supports, and the impacting of the centrally located spacer grid by means of an impact member on the side opposite the stationary support against which the centrally located spacer grid is applied;
the impact member is mounted movably by means of a pendulum or along a rail to project it against the centrally located spacer grid;
in a one-sided impact test, generating an impact comprises projecting the entire test assembly against a stationary support such that the test assembly impacts the stationary support via the centrally located spacer grid;
a combined impact test, generating an impact comprises projecting the test assembly as a whole against a stationary support so that the centrally located spacer grid impacts the stationary support from one side, in conjunction with impacting the centrally located spacer grid with an impact member from the opposite side of the centrally located spacer grid;
the testing method includes heating the test assembly upon performing of the test.

The present disclosure also relates to a test machine for performing a method of testing a spacer grid of a nuclear fuel assembly, the test machine being configured to perform the test on a test assembly comprising a bundle of test rods shorter than the nuclear fuel rods and three spacer grids distributed along the test rods, the test machine comprising at least one stationary support, each stationary support being arranged to serve as a support or impact point for a spacer grid, the test machine being configured for generating an impact against the spacer grid of the test assembly located centrally between the other two spacer grids, and comprising a measuring device configured for measuring and recording at least one impact parameter and/or at least one displacement of said centrally located spacer grid.

According to particular embodiments, the test machine comprises one or more of the following optional features, taken individually or in any technically possible combination:
the test machine comprises three stationary supports spaced apart so as to support the three spacer grids, and an impact device comprising an impact member movable so as to be projected against the centrally located spacer grid on the side opposite the stationary support against which the centrally located spacer grid is applied;
the test machine comprises a stationary support and a launching device configured to launch the test assembly towards the stationary support in such a way that the test assembly strikes the stationary support via the centrally located spacer grid;
the test machine includes an impact device comprising an impact member and configured to cause the impact member to impact the centrally located spacer grid on the side opposite the stationary support when the centrally located spacer grid impacts the stationary support.
the test machine comprises a heating device configured to heat the test assembly upon performing the test, to reproduce the conditions prevailing in the nuclear reactor.

### BRIEF DESCRIPTION OF THE DRAWINGS

The present disclosure and its advantages will be better understood upon reading the following description given only as a non-limiting example and made with reference to the attached drawings, in which:

FIG. 1 is an elevation view of a nuclear fuel assembly;

FIG. 2 is a schematic view of a test assembly arranged in a test machine with impact on two sides;

FIG. 3 is a schematic view of a test assembly in a one-sided impact test machine;

FIG. 4 is a schematic view of a test assembly arranged in a combined test machine.

### DETAILED DESCRIPTION

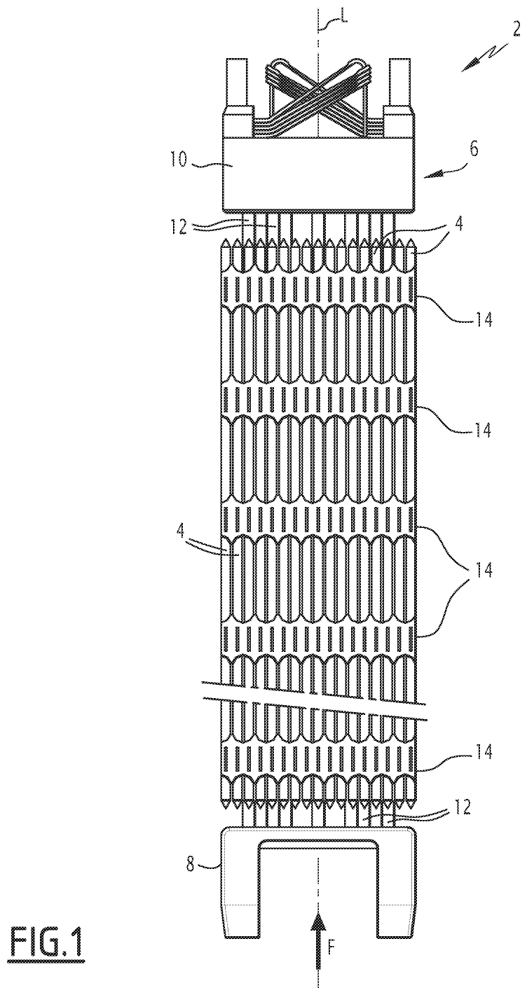

The nuclear fuel assembly 2 of FIG. 1 includes a bundle of nuclear fuel rods 4 and a support skeleton 6 configured to support the nuclear fuel rods 4.

The nuclear fuel rods 4 extend parallel to each other and to a longitudinal axis L.

In operation, the nuclear fuel assembly 2 is placed in a core of a nuclear reactor formed of a plurality of nuclear fuel assemblies 2 arranged side-by-side with the longitudinal axis L extending vertically. A coolant flows vertically from bottom to top through the nuclear fuel assembly 2 as shown by arrow F in FIG. 1.

In the remainder of the description, the terms “vertical”, “horizontal”, “top”, “bottom”, “longitudinal”, “transverse”, “lower” and “upper” are understood to refer to the position of the nuclear fuel assembly 2 in the nuclear reactor core, with the longitudinal axis L being substantially vertical.

The support skeleton 6 includes a bottom nozzle 8, a top nozzle 10, a plurality of guide tubes 12 and a plurality of spacer grids 14.

The bottom nozzle 8 and the top nozzle 10 are spaced apart along the longitudinal axis L.

The guide tubes 12 extend along the longitudinal axis L and connect the bottom nozzle 8 and the top nozzle 10 together with maintaining the spacing between the bottom nozzle 8 and the top nozzle 10 along the longitudinal axis L. The nuclear fuel rods 4 are received between the bottom nozzle 8 and the top nozzle 10.

Each guide tube 12 is open at its upper end to allow insertion of a control rod within the guide tube 12 through the top nozzle 10. Such a control rod is used to control the reactivity of the nuclear reactor core into which the nuclear fuel assembly 2 is inserted.

The spacer grids 14 are distributed along the guide tubes 12 in spaced apart relation along the longitudinal axis L. Each spacer grid 14 is rigidly attached to the guide tubes 12, the guide tubes 12 extending through each spacer grid 14.

A nuclear fuel assembly for a pressurized water reactor or a boiling water reactor generally has a length between 2.4 m and 6 m and a number of spacer grids comprised between 2 and 15, more particularly a number of spacer grids comprised between 5 and 11.

The nuclear fuel assembly 2 includes N spacer grids 14, where N is a positive integer equal to or greater than four.

Each spacer grid 14 is configured to support the nuclear fuel rods 4 in a configuration in which they are transversely spaced from each other. The nuclear fuel rods 4 are preferably held at nodes of a substantially regular imaginary network.

Each spacer grid 14 includes for example a plurality of rod cells, each rod cell for receiving a respective nuclear fuel rod 4, the walls of the rod cell being provided with support members engaging the outer surface of the nuclear fuel rod 4 to hold it longitudinally and transversely.

The support members of each rod cell include, for example, at least one resilient spring and/or at least one rigid dimple, each spring being configured, for example, to urge the nuclear fuel rod 4 into abutment with one or more dimples.

A nuclear reactor core is formed by a plurality of nuclear fuel assemblies 2 arranged vertically side-by-side in a nuclear reactor vessel.

In certain situations, in particular in the event of an earthquake, these nuclear fuel assemblies 2 may collide with each other or with side walls of the nuclear reactor vessel, in particular through their spacer grids 14.

During the design of nuclear fuel assembly 2, spacer grids 14 contemplated for use in nuclear fuel assembly 2 should be tested to certify them for operational use in a nuclear reactor.

Each test of a spacer grid 14 should validate the sufficient strength of the spacer grid 14 in situations representative of what may occur during the operation of a nuclear reactor, particularly in the event of an earthquake or LOCA incident.

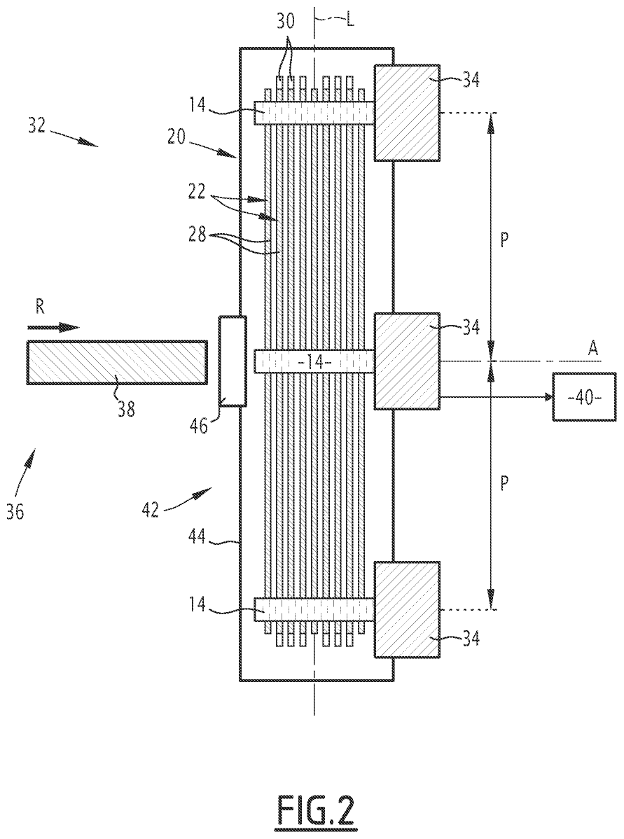

Advantageously, and as illustrated in FIGS. 2 through 4, a method of testing a spacer grid designed for a nuclear fuel assembly 2 comprises:
providing a test assembly 20 corresponding to a section of the nuclear fuel assembly 2 shorter than the nuclear fuel assembly 2, the test assembly 20 comprising a bundle of test rods 22 and three spacer grids 14 distributed along the test rods,
generating an impact on the centrally located spacer grid 14, and
measuring and recording at least one impact parameter and/or at least one displacement of the first spacer grid 14.

The test assembly 20 extends along a longitudinal axis L with being shorter than the nuclear fuel assembly 2. Preferably, the test assembly 20 is deprived of a bottom nozzle 8 or a top nozzle 10.

The test rods 22 are shorter than the nuclear fuel rods 4. Each test rod 22 is for example provided in the form of a tube 28, in particular a tube formed from a section of a tubular sheath of a nuclear fuel rod 4.

The tube 28 of each test rod 22 is for example filled with pellets, in particular with tungsten carbide pellets which have a density close to or equal to that of nuclear fuel pellets, in particular uranium dioxide pellets.

The spacer grids 14 of the test assembly 20 are identical to those of the nuclear fuel assembly 2.

Each test rod 22 is received in a respective rod cell of each of the spacer grids 14 of the test assembly 20.

Preferably, the test assembly 20 includes test guide tubes 30 passing through the spacer grids 14 of the test assembly 20, which are preferably attached to these test guide tubes 30, as the spacer grids 14 of the nuclear fuel assembly 2 are attached to the guide tubes 12 of the nuclear fuel assembly 2.

The spacing P between the spacer grids 14 of the test assembly 20 corresponds to that between the spacer grids 14 of the nuclear fuel assembly 2.

Thus, the test assembly 20 replicates a section of the nuclear fuel assembly 2 extending over a limited length of the nuclear fuel assembly 2 corresponding to three spacer grids 14.

This provides a test assembly 20 that can behave in a manner representative of that of a nuclear fuel assembly 2, particularly in the test situations that are implemented, while facilitating the performance of the tests.

As illustrated in FIG. 2, a two-sided impact test machine 32 is provided for performing a two-sided impact test on the test assembly 20.

The two-sided impact test machine 32 includes three stationary supports 34 spaced apart so as to bring the test assembly 20 into abutment against the three supports 34 via the three spacer grids 14, each one of the three spacer grids 14 of the test assembly 20 abutting a respective one of the stationary supports 34 along an impact direction A that is substantially perpendicular to the longitudinal axis L of the test assembly 20.

The two-sided impact testing machine 32 comprises an impact device 36 comprising a percussion member 38 movable so as to impact the centrally located spacer grid 14 on the side opposite the fixed lateral support 34 against which this centrally located spacer grid 14 is abutted.

The two-sided impact testing machine 32 includes a measuring device 40 configured to measure and record at least one impact parameter and/or at least one displacement of the centrally located spacer grid 14.

Optionally, the two-sided impact test machine 32 includes a heating device 42 configured to heat the test assembly 20 for performing the two-sided impact test. The heating 42 is performed prior to and/or during the impacting of the centrally located spacer grid 14 with the impact member 38.

The heating device 42 includes for example a heating enclosure 44, with the test assembly 20 disposed within the heating enclosure 44 for performing the two-sided impact test. The heating enclosure 44 includes, for example, a passageway opening 46 to allow passage of the impact member 38.

The impact member 38 is mounted so as to be movable with respect to the stationary supports 34 so as to impact the spacer grid 14 located in a central position.

For this purpose, as illustrated by arrow R in FIG. 2, the impact member 38 is for example mounted to slide in the impact direction A or is mounted on a pendulum so as to impact the spacer grid 14 located in the central position in the impact direction A.

The percussion member 38 mounted on a pendulum describes a circular trajectory before impacting the spacer grid 14 located in a central position along the impact direction A.

The impact member 38 is, for example, in the form of a mass, in particular a metal mass.

The two-sided impact test implementable with the two-sided impact testing machine 32 comprises applying the spacer grids 14 of the test assembly 20 against the respective stationary supports 34 along the impact direction A, and then impacting the centrally located spacer grid 14 with the impact member 38 on the side opposite the stationary support 34 against which the centrally located spacer grid 14 is applied, along the impact direction A.

Thus, when the impact member 38 strikes the centrally located spacer grid 14, the latter is compressed between the impact member 38 and the stationary support 34 against which the centrally located spacer grid 14 is applied.

Optionally, implementation of the two-sided impact test includes heating the test assembly 20 prior to and/or during impact generation, for example using the heating device 42 of the two-sided impact testing machine 32.

For example, the test assembly 20 is heated to a temperature between 300° C. and 350° C. Such a temperature range corresponds to a temperature range inside a nuclear reactor core during normal operation.

The two-sided impact test tests the strength of the centrally located spacer grid 14 while recognizing that in practice, in a nuclear fuel assembly 2, an impact to a spacer grid 14 is taken up in part by that impacted spacer grid 14 and in part by the spacer grids 14 on either side of that impacted spacer grid 14.

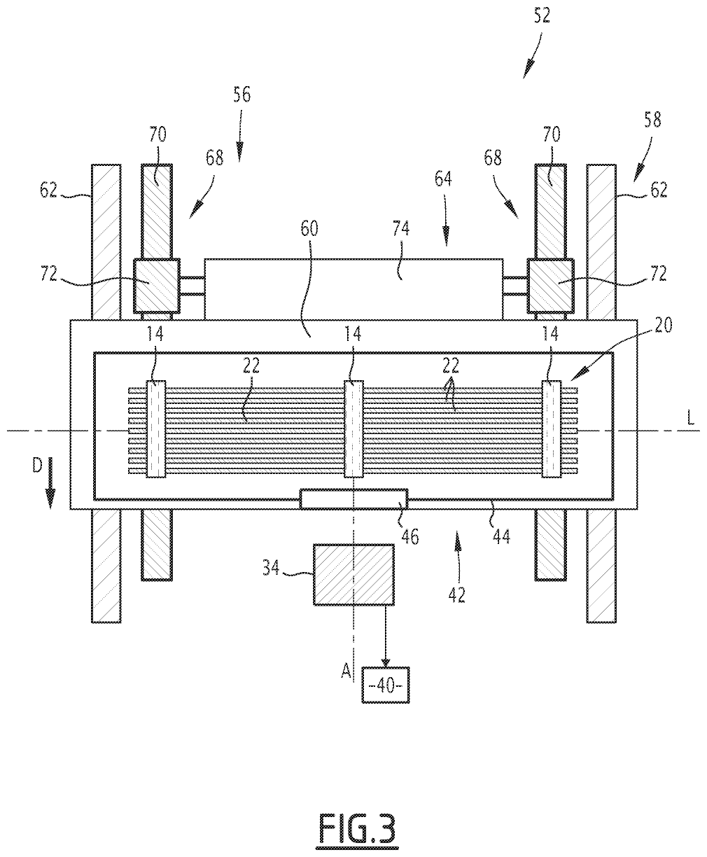

As illustrated in FIG. 3, in which numerical references to analogous elements have been retained, a one-side impact test machine 52, configured to implement a one-side impact test, comprises a stationary support 34 and a launching device 56 configured to launch the test assembly 20 against the stationary support 34 such that the test assembly 20 impacts the stationary support 34 through the centrally located spacer grid 14 along an impact direction A that is perpendicular to the longitudinal axis L of the test assembly 20.

The launching device 56 includes, for example, a guide device 58 comprising a launch support 60 configured to support the test assembly 20, the launch support 60 being slidably mounted along guide rails 62 extending along the direction of impact A, and a drive device 64 for driving the launch support 60 carrying the test assembly 20 toward the stationary support 34 so that the test assembly 20 impacts the stationary support 34 through the centrally located spacer grid 14.

The drive device 64 includes, for example, at least one rack and pinion system 68, each rack and pinion system 68 including a rack 70 and a pinion 72 meshing with the rack 70, the pinion 72 being connected to an actuator 74 configured to rotate the pinion 72 to drive the launch support 60. Preferably, the rack 70 of each rack and pinion system 68 is fixed, with the pinion 72 mounted on the launch support 60.

In one example embodiment, the drive arrangement 64 includes at least two rack and pinion systems 68, in particular exactly two rack and pinion systems 68.

Each actuator 4 is for example a motor, in particular an electric motor.

Advantageously, the drive device 64 comprises an actuator 74 driving the pinions 72 of at least two rack and pinion systems 68.

In a particular embodiment, as shown in FIG. 3, the drive device 64 has two rack and pinion systems 68 with the rack 70 fixed and the pinion 72 mounted on the launch support 60, and an actuator 74 driving the two pinions 72 of the rack and pinion systems 68 to drive the launch support 60.

Optionally, the one-side impact test machine 52 includes a heater 42 to heat the test assembly 20 for performing the one-side impact test. The heating is performed prior to and/or during the impact of the test assembly 20 against the stationary support 34.

The heating device 42 includes, for example, a heating enclosure 44, with the test assembly 20 disposed within the heating enclosure 44 for performing the one-side impact test.

The heating enclosure 44 is, for example, carried by the launch support 60. Preferably, it includes a through opening 46 to allow insertion of the stationary support 34 into the heating enclosure 44 when the test assembly 20 impacts the stationary support 34.

A one-sided impact test implementable using the one-sided impact test machine 52 comprises generating an impact with the launch of the test assembly 20 as a whole against the stationary support 34 along an impact direction A perpendicular to the longitudinal axis L of the test assembly 20, such that the test assembly 20 impacts the stationary support 34 along the impact direction A through the centrally located spacer grid 14.

The test assembly 20 is mounted on the launch support 60, and then the launch support 60 is driven toward the stationary support 34 by the drive device 64 such that the test assembly 20 impacts the stationary support 34 along the impact direction A through the centrally located spacer grid 14.

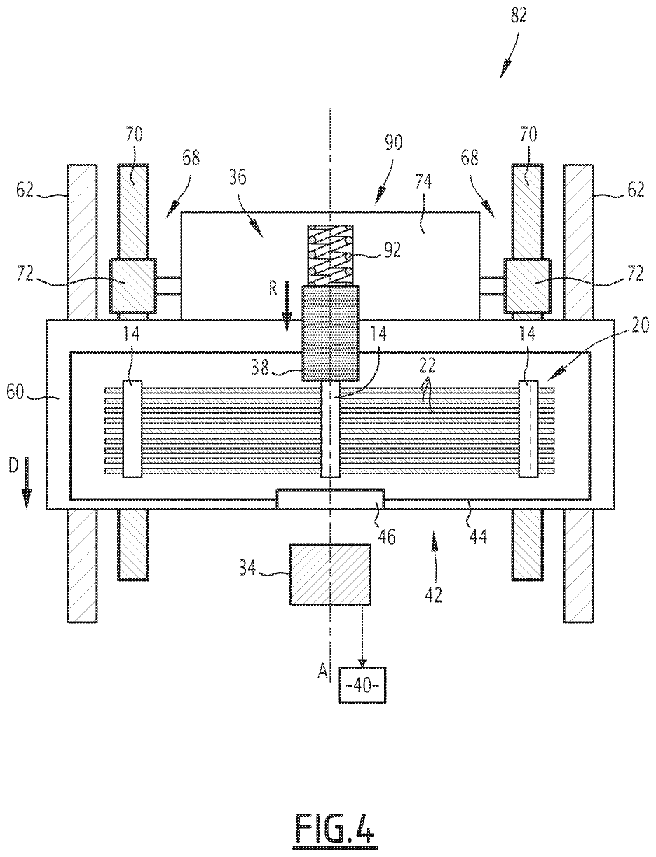

As illustrated in FIG. 4, in which numerical references to elements similar to those in FIG. 3 are repeated, a combined test machine 82 differs from the one-side impact test machine 52 in that it further comprises a secondary impact device 36 configured to generate an impact on the centrally located spacer grid 14 on the opposite side from the stationary support 34 and substantially at the time of impact of the centrally located spacer grid 14 against the stationary support 34.

The secondary impact device 36 comprises, for example, an impact member 38 mounted on the launch support 60 and being translationally movable along the impact direction A (see arrow R on FIG. 4) with respect to the launch support 60, so as to impact the centrally located spacer grid 14 on the side opposite the stationary support 34 when the centrally located spacer grid 14 impacts the stationary support 34.

The impact member 38 is, for example, a mass, in particular a metallic mass.

As a result, during the combined test, implemented with the combined test machine, the centrally located spacer grid 14 is compressed between the impact member 38 and the stationary support 34.

The impact member 38 is, for example, mounted on the launch support 60 by means of a linear guide system 88 allowing the impact member 38 to slide in translation relative to the launch support 60 along the impact direction A.

The third test machine 82 is configured so that the test assembly 20 can be disposed on the launch support 60 between the impact member 38 and the stationary support 34 and launched against the stationary support 34.

In one embodiment, the secondary impact device 36 is configured such that the impact member 38 impacts the centrally located spacer grid 14 solely due to the inertia of the impact member 38 driving the impact member 38 toward the centrally located spacer grid 14 upon impact with the stationary support 34.

Optionally, the secondary impact device 36 includes, for example, a projection system 90 for generating a force to project the impact member 38 against the centrally located spacer grid 14.

The projection system 90 includes, for example, a resilient member 92, such as a spring, configured to store mechanical energy and release it by projecting the impact member 38 against the centrally located spacer grid 14 upon impact of the centrally located spacer grid 14 against the stationary support 34.

For example, the projection system 90 includes a retainer system (not shown) configured to retain the impact member 38 against action of the resilient member 92 prior to impact of the centrally located spacer grid 14 against the stationary support 34 and to release the impact member 38 upon impact of the centrally located spacer grid 14 against the stationary support 34.

In operation, to perform the combined test, the test assembly 20 is placed on the launching support 60, with the stationary support 34 and the percussion member 38 located thereon, and then the support 60 is set in motion with the aid of the drive device 62 to launch the test assembly 20 against the stationary support 34.

The impact member 38 strikes the centrally located spacer grid 14 when the spacer grid 14 strikes the stationary support 34 from the side opposite the stationary support 34 due to its inertia and/or the effect of the projection system 90.

The spacer grid 14 located in the central position is thus subjected to two simultaneous impacts on two opposite sides, one against the stationary support 34 and the other by the impact member 38.

The secondary impact generated by the percussion member 38 can be adjusted, for example by adjusting the mass of the percussion member 38 and/or, if necessary, by adjusting the projection force generated by the projection system 90.

The combined test enables a situation to be reproduced which is close to what happens in reality, for example in the event of an earthquake, with the nuclear fuel assemblies 2 colliding with each other so that spacer grids 14 are impacted simultaneously on two opposite sides.

With the present disclosure, it is possible to test a spacer grid 14 of a nuclear fuel assembly 2 reliably and accurately, by repeatedly reproducing stresses potentially encountered by the spacer grid 14 during normal operation or in the event of an earthquake or LOCA.

The use of a test assembly 20 reproducing a section of nuclear fuel assembly 2 over a fraction of the length of the nuclear fuel assembly 2 corresponding to three spacer grids 14 allows for easy yet realistic testing.

A test protocol includes, for example, a one-side impact test (in which the test assembly 20 is held stationary against stationary supports 34), a two-sided impact test (in which the test assembly 20 is thrown against a stationary support 34), and/or a combined test (in which the test assembly 20 is thrown against a stationary support 34, with an impactor 38 impacting the centrally located spacer grid 14 on the side opposite the stationary support 34 impacted by that centrally located spacer grid 14).

As in the illustrated examples, the test assembly 20 preferably includes three spacer grids 14, thereby providing a short test assembly 20 that is easily manipulated while still allowing representative tests to be performed.

Alternatively, the test assembly 20 may include more than three spacer grids 14, for example four or five spacer grids 14.

In any case, the spacer grid 14 impacted during testing is located along the test assembly 20 between two other spacer grids 14.

Furthermore, in all cases, the test assembly 20 includes a number M of spacer grids 14, where the number M is a positive integer equal to or greater than three.

The number M of spacer grids 14 of the test assembly 20 is preferably strictly inferior to the number N of spacer grids 14 of the corresponding nuclear fuel assembly 2.

The term “spacer grid” here refers specifically to the spacer grids 14, i.e. the grids that are fixed to the guide tubes 12 and provide the function of supporting the nuclear fuel rods 4, excluding, in particular, the mixing grids.

A mixing grid is a grid that may be disposed along the nuclear fuel rods 4, the mixing grid having the function of diverting a coolant flowing from the bottom up through the nuclear reactor core to provide mixing of the coolant between different areas of the nuclear reactor core. Each mixing grid is generally located along the nuclear fuel rods 4 between two spacer grids 14, below the lowest spacer grid 14 or above the highest spacer grid 14.

Optionally, the test assembly 20 is provided with one or more mixing grids located along the test rods. The mixing grids are not considered in determining the number M of spacer grids 14 in the test assembly.

1. A method of testing a spacer grid of a nuclear fuel assembly comprising a bundle of nuclear fuel rods and N spacer grids distributed along the bundle of nuclear fuel rods, where N is a positive integer equal to or greater than four, the testing method comprising:
providing a test assembly corresponding to a section of the nuclear fuel assembly extending on a fraction of a length of the nuclear fuel assembly, the test assembly comprising a bundle of test rods shorter than the nuclear fuel rods and three spacer grids distributed along the test rods;
generating an impact on a centrally located spacer grid of the three spacer grids, and
measuring and recording at least one impact parameter and/or at least one displacement of said centrally located spacer grid.

2. The testing method according to claim 1, wherein the test assembly comprises exactly three spacer grids.

3. The testing method according to claim 1, wherein, in a two-sided impact test, generating an impact comprises applying the spacer grids against a stationary support, and impacting the centrally located spacer grid with an impact member on a side opposite the stationary support against which the centrally located spacer grid is applied.

4. The testing method according to claim 3, wherein the impact member is movably mounted by a pendulum or along a rail to project the impact member against the centrally located spacer grid.

5. The testing method according to claim 1, wherein, according to a one-sided impact test, generating an impact comprises projecting the test assembly as a whole against a stationary support so that the test assembly impacts the stationary support via the centrally located spacer grid.

6. The testing method according to claim 1, wherein in a combined impact test, generating an impact comprises projecting the test assembly as a whole against a stationary support such that the centrally located spacer grid impacts the stationary support from one side, in conjunction with impacting the centrally located spacer grid with an impact member on an opposite side of the centrally located spacer grid.

7. The testing method according to claim 1, further comprising heating the test assembly upon performing the test.

8. A test machine for performing a method of testing a spacer grid of a nuclear fuel assembly, the test machine being configured to perform the test on a test assembly comprising a bundle of test rods shorter than the nuclear fuel rods and three spacer grids distributed along the test rods, the test machine comprising:
at least one stationary support, each stationary support being arranged to serve as a support or impact point for one of the spacer grids, the test machine being configured for generating an impact against one of the three spacer grids of the test assembly located centrally between the other two of the three spacer grids; and
a measuring device configured for measuring and recording at least one impact parameter and/or at least one displacement of said centrally located spacer grid.

9. The test machine according to claim 8, further comprising three stationary supports spaced apart so as to support the three spacer grids, and an impact device comprising an impact member movable so as to be projected against the centrally located spacer grid on the opposite side of the stationary support against which the centrally located spacer grid is applied.

10. The test machine according claim 8, further comprising a stationary support and a launching device configured to launch the test assembly toward the stationary support such that the test assembly impacts the stationary support via the centrally located spacer grid.

11. The test machine of claim 10, further comprising an impact device comprising an impact member and configured for the impact member to impact the centrally located spacer grid on a side opposite the stationary support when the centrally located spacer grid impacts the stationary support.

12. The test machine of claim 8, further comprising a heater configured to heat the test assembly upon performing the test to replicate the conditions in the nuclear reactor.
